(19) United States
(12) Patent Application Publication
(10) Pub. No.: US 2015/0243025 A1
(43) Pub. Date: Aug. 27, 2015

(54) ISOCENTRIC PATIENT ROTATION FOR DETECTION OF THE POSITION OF A MOVING OBJECT

(71) Applicant: BRAINLAB AG, Feldkirchen (DE)

(72) Inventors: Kajetan Berlinger, Muenchen (DE); Stephan Froehlich, Aschheim (DE)

(73) Assignee: Brainlab AG, Feldkirchen (DE)

(21) Appl. No.: 14/431,831

(22) PCT Filed: Sep. 28, 2012
(86) PCT No.: PCT/EP2012/069205

§ 371 Date: Mar. 27, 2015

(51) Int. Cl. G06T 7/00; G06T 7/20

(52) U.S. Cl. CPC G06T 7/0012; G06T 7/20; G06T 7/004; G06T 2207/10081; G06T 2207/10112

(57) ABSTRACT

The invention relates to a method for determining the position of an object moving within a body, wherein the body is connected to markers, a movement signal is determined based on the measured movement of the markers, images are taken from the object using a camera or detector, wherein the camera or detector is moved with respect to the object, it is determined from which direction or range of angles or segment the most images corresponding to a predefined cycle of the movement signal are taken, and using at least some or all of the images of the segment containing the most images for a specified movement cycle, an image of the object is reconstructed.

The present invention relates generally to the detection of the position or state of a moving object, preferably the detection of the position of an object moving within a body, such as for example the position of an organ or a tumour within a patient. The invention relates especially to image sequence matching for respiratory state detection, which can be used for extracranial radiosurgery.

The invention relates also to the determination of the respiratory state by matching a pair or series of x-ray images, which are for example taken during free-breathing, to a corresponding 4D volume scan.

To apply radiosurgical methods to tumours in the chest and abdomen, it is necessary to take into account respiratory motion, which can move the tumour by more than 1 cm. It is known to use implanted fiducials to track the movement of the tumour.

It is also known to track the movement of tumours without implanted fiducials. Reference is made to K. Berlinger, “Fiducial-Less Compensation of Breathing Motion in Extracranial Radiosurgery”, Dissertation, Fakultät für Informatik, Technische Universität Münch en; K. Berlinger, M. Roth, J. Fisseler, O. Sauer, A. Schweikard, L. Vences, “Volumetric Deformation Model for Motion Compensation in Radiotherapy” in Medical Image Computing and Computer-Assisted Intervention-MICCAI 2004, Saint Malo, France, ISBN: 3-540-22977-9, pages 925-932, 2004 and A. Schweikard, H. Shiomi, J. Fisseler, M. Dötter, K. Berlinger, H. B. Gehl, J. Adler, “Fiducial-Less Respiration Tracking in Radiosurgery” in Medical Image Computing and Computer-Assisted Intervention—MICCAI 2004, Saint Malo, France, ISBN: 3-540-22977-9, pages 992-999, 2004.

U.S. Pat. No. 7,260,426 B2 discloses a method and an apparatus for locating an internal target region during treatment without implanted fiducials. The teaching of U.S. Pat. No. 7,260,426 B2 with respect to a radiation treatment device, as illustrated in FIG. 1 of U.S. Pat. No. 7,260,426 B2, and with respect to a real-time sensing system for monitoring external movement of a patient, is herewith included in this application.

U.S. application Ser. No. 10/652,786 discloses an apparatus and a method for registering 2D radiographic images with images reconstructed from 3D scan data.

It is known to place external markers, such as IR-reflectors or IR-emitters, on a patient. The markers can be tracked automatically with known optical methods at a high speed to obtain a position signal, which can for example be a breathing signal or a pulsation signal, being indicative of for example the respiratory state.

However, the markers alone cannot adequately reflect internal displacements caused for example by breathing motion, since a large external motion may occur together with a very small internal motion, and vice versa.

A method known from EP 2 070 478 A1 encompasses determining a movement signal based on the measured movement of the markers, pre-segmenting all possible acquisition angles at which the position of the markers is determined into divisions (segments), and taking images of an object moving within the body to which the markers are connected from different angles and in more than one of the segments. In that method, the camera or detector is moved with respect to the object partly or fully around the object through more than one of the segments. A tomographic image of the objects is then reconstructed by digital tomosynthesis based on the images taken in the segment which contains the most images for a specified movement cycle of the object. The additional images are in particular taken at different angles which are caused by for example rotation of the gantry of a CT imaging apparatus.

The approach of EP 2 070 478 A1 is, however, limited to using an image apparatus which allows for movement of an imaging detector, for example an X-ray detector in order to allow the generation of images based on digital tomosynthesis.

### SUMMARY OF THE INVENTION

It is an object of the invention to provide a method and an apparatus for determining the position of a moving object, such as for example a tumour, within a body, such as for example a patient, which method and apparatus can be flexibly employed with different types of imaging apparatuses. In particular, the inventive method and apparatus shall be usable with X-ray-based (medical) imaging apparatuses which do not allow for movement of an X-ray source and/or a detector (camera). The movement of the object within the body can e.g. be caused by respiratory motion.

This object is solved by the method and the apparatus as defined in the independent claims. Preferred embodiments are defined in the dependent claims.

A method and an apparatus for detecting the state of a moving body or object, such as for the detection of the respiratory state and the corresponding position of an object moving within the body, is presented.

The method can involve the use of a first dataset, such as a plurality or series of first images that each show an internal volume of the body, preferably including the internal object or target region. The plurality or series of first images can for example be a sequence of computer tomography (CT) images each including three-dimensional information about the body and/or the object. A series of 3D CT data sets or images covering a specific period, such as e.g. at least one breathing cycle, is hereinafter referred to as a 4D CT.

Each 3D CT can be segmented to obtain information about for example the position and/or outline and/or surface of an object, such as tumour, within the body or patient. Using a series of segmented 3D CTs, the movement of the object in the first dataset can be determined.

The problem is that the object or tumour moves probably at a time later than that of acquiring the first dataset within the body in a (slightly) different way due to e.g. respiration or pulsation, since e.g. the shape of the tumour has slightly changed, or since the patient's resting position is slightly changed. For subsequent treatment e.g. by radiation, however, the current position of the object or tumour should be determined without the need to make a 4D CT.

According to an aspect of the invention, digital tomosynthesis (DTS) is used to register the patient or to obtain the current position information of the object or tumour moving within the body or patient, especially to determine the position of the object for a specific moving or respiratory state.

Digital tomosynthesis is a limited angle method of image reconstruction. A sample of protection images is used to reconstruct image plains through the object of choice. The back projection of the projection images on the tomographic image plane yields an accumulated destination image. Objects not located close to the tomographic plane will be blurred in the image, but objects like a tumour, which are located in the isocentre of the machine, will be intensified.

In general, a digitally captured image is combined with the motion of the patient or at least parts of the patient's body relative to the isocentre of the (medical) imaging apparatus. The movement is in particular an isocentric movement, i.e. the position of the patient's body relative to the isocentre preferably does not change during the movement. In particular, the body (or part of it) is rotated around the isocentre, i.e. the isocentre is the centre of rotation. In other words, the at least part of the patient's body is rotated around at least one axis which runs through the isocentre. Preferably, the patient is rotated at least once, according to an embodiment of the invention the patient is rotated a plurality of times, i.e. at least twice, more specifically exactly twice. The rotation angle may be the same or different between each of the rotations. Contrary to CT, where the source or detector makes a complete 360 degree rotation about the object, to obtain a complete set of data from which images may be reconstructed, only a small rotational (rolling) angle of the patient's body around its cranial-caudal axis, such as for example 5 or 40 degrees, and/or yawing angle, such as for example 5 or 40 degrees, of the patient's body in its frontal plane and/or a small pitch angle of the patient's body (i.e. angle between the horizontal plane and the frontal plane of the patient's body), such as for example 5 or 40 degrees, with a small number of discrete exposures, such as for example 10, are used for digital tomosynthesis. This incomplete set of data can be digitally processed to yield images similar to conventional tomography with a limited depth of field. However, because the image processing is digital, a series of slices at different depths and with different thicknesses can be reconstructed from the save acquisition, thus saving both time and radiation exposure. Preferably, the patient is first pre-positioned to have the object such as a tumour roughly positioned in the isocentre of the imaging apparatus which comprises an (imaging) irradiation source (in particular, X-ray source) and a corresponding detector. After that, the system used for conducting the inventive method (comprising e.g. a patient support mean such as a bed, a therapeutic irradiation means such as a linear accelerator and an imagining apparatus such as a C-arc X-ray device or CT device) rotates, in particular pivots, the patient around the isocentre of the imaging device during acquisition of the images, in particular the patient is moved in in particular 3 degrees of freedom around the pre-positioned object to be imaged. The isocentre is understood to be defined as a point (or set of points) and/or volume in space which, regardless of orientation of the beam source of the scanner relative to the longitudinal moving direction of the scanner, remains in the focus of the imaging beam and is therefore always imaged in any possible beam source position. The pre-positioning of the patient (in particular, the object) in the isocentre and movement of the patient (rotation of the patient) around the isocentre are useful because the object (the tumour) which is presently of interest then is in the (optical) imaging focus for digital tomosynthesis image generation. The target (object, in particular tumour) will always in the focus of the imaging device regardless of the rotation state of the patient. Objects not located in or close to the isocentre will be blurred in the digital tomosynthesis image, but the image information about the target will be enriched. For conventional linear accelerators with 4 degrees of freedom it is also within the framework of the invention to rotate the patient only in a vertical direction during acquisition of the X-ray images as a vertical rotation is always an isocentric rotation. Treatment systems providing 6 degrees of freedom may in the framework of the invention additionally rotate the patient during acquisition of the X-ray images in lateral and longitudinal directions. Thereby, image information from projection images from a plurality of directions would be available for digital tomosynthesis image generation, which would further enhance the probability of receiving information about a contact of soft tissue with the target which for some medical applications is of interest.

Since the body is moving during image acquisition due to vital movements (such as a movement of the thorax due to breathing), motion artefacts are generated. According to the present invention, these artefacts can be avoided.

The current state of respiration during image acquisition is recorded using for example the above-mentioned IR markers attached to the surface or a part of the surface of the object or patient moving due to e.g. respiration.

Each periodic or almost periodic movement or motion, such as respiration or pulsation, is divided into sections, such as e.g. respiratory states, as shown in an embodiment in FIG. 2. The respiratory state can be for example: inhaled, nearly inhaled, intermediate, nearly exhaled and exhaled. However, a coarser or finer division of the periodic signal or IR-respiratory curve can also be used.

Cone-beam computed tomography (CBCT) is a data acquisition method being able to provide volumetric imaging, which allows for radiographic or fluoroscopic monitoring throughout a treatment process. Cone-beam CT acquires a series of projections or images over at least a part of or the entire volume of interest in each projection. Using well-known reconstruction methods, the 2D projections can be reconstructed into a 3D volume analogous to a CT planning data set.

According to the present invention, cone-beam CT raw images are taken preferably at different rotational states of the patient's body and the time of the respective image acquisition is recorded and correlated to a movement signal, such as the IR-respiratory curve. Thus, it is known for every acquired image to which movement or respiratory state it belongs and from which direction it was taken. The rotational state of the patient's body is understood to be defined in particular by the orientation of the patient's frontal plain relative to a coordinate system in which the target (object, in particular tumour) preferably rests. Advantageously, the origin of such a coordinate system is located in the (position of the) target. Where this disclosure refers to a direction and/or angle of imaging, such a direction and/or angle is understood to be defined by the aforementioned orientation of the frontal plain of the patient's body. As it is understood by the skilled person, this also implies a corresponding orientation of the patient's body relative to the imaging device (i.e. relative to the position of an X-ray source and an X-ray detector). After recording several images together with this time and position information, it is analyzed for every movement or breathing state from which direction or angle or range of angles the most images have been taken. In other words, it is determined for e.g. a pre-segmented division of all possible acquisition angles, in which segment the largest number of images has been taken.

Using this accumulation of images taken from different angles lying within a predefined segment or within a predefined range of angles, digital tomosynthesis (DTS) is computed to obtain a DTS-image of the object of interest.

It is possible to additionally consider images from the segment opposing the segment with the most images for improving the generated DTS image. It will be understood that the data of the opposing segment has to be mirrored to be used as additional data for improving the DTS-image.

Additionally, at least one further image being preferably taken under a different angle, such as perpendicular to the calculated DTS-image, can be taken into account for the same respiratory state. Thus, the 3D shape or position of the object of interest or tumour can be calculated. For example, if the main direction of the motion of the object is the same or close to the viewing direction of the reconstructed DTS image, it is quite difficult to obtain accurate registration results. However, if a further image is taken into account which image is taken from a different viewing angle, such as plus or minus 90 degrees, registration is quite simple.

Preferably tomographic images are computed for multiple or all respiratory states.

Using the known or recorded camera parameters of every tomographic image, such as the angle of bisector, and the segmentation data of the corresponding respiratory state (e.g. from a prior 4D CT), hereinafter referred to as “bin”, the shape of the target can be computed and can be superimposed on the image.

Small deviations can be compensated for using an intensity-based registration to obtain an accurate position of a target in every tomographic image, thus yielding an updated trajectory. In other words, the current position of an object or tumour at a specific time or breathing cycle can be calculated using e.g. an earlier taken segmented 4D CT and several DTS images, which eliminates the need for a further CT. Thus, the trajectory of a tumour can be updated.

The invention relates further to a computer program, which, when loaded or running on a computer, performs at least one of the steps of the method disclosed herein. Furthermore, the invention relates to a program storage medium or computer program product comprising such a program.

An apparatus for determining the position of an object moving within a (patient's) body comprises a tracking system, such as an IR tracking system, which can detect the position of external markers fixed to at least part of the surface of the moving body; a (medical) imaging apparatus comprising an (imaging) irradiation source (in particular, an X-ray source such as an X-ray tube) and a corresponding detector for taking images of the body; wherein the detector is in particular an X-ray detector which is in particular part of a fixed X-ray geometry (i.e. in particular cannot be moved relative to a coordinate system in which in particular the isocentre of the imaging apparatus rests) and means for rotating the body in an isocentric movement with respect to the imaging isocentre of the imaging apparatus; the detector and the tracking system preferably are connected to a computational unit correlating the marker signals being movement signals obtained by the tracking system and the detector signals including the image data and image parameters comprising at least the time the image has been taken and the rotational state of the patient's body at the time the image was taken, the computational unit determining a segment or viewing range within or from which the most images were taken and elects this segment for image reconstruction, preferably by DTS.

According to a further aspect the invention relates to a treatment method using the position or trajectory of the object to be treated determined by the above described method, for controlling and/or guiding a radiation source, especially controlling and guiding the position of the radiation source from which the body or object is irradiated together with switching the radiation source on and off depending on the state of the object or body, especially the position of the object within the body, preferably considering the position of other objects which should probably not be irradiated.

According to a further aspect, the invention relates to the matching of image sequences, preferably for respiration state detection, which can be used in extracranial radiosurgery. For extracranial radiosurgery the motion of a body, such as e.g. the respiratory motion (i.e. the motion may be caused by a breathing) or pulsation motion (i.e. the motion may be caused by a pulsation signal), has to be considered, since this motion may cause a tumour to shift its position by more than 1 cm. Without compensating this motion, it is unavoidable to enlarge the target volume by a safety margin, so that also healthy tissue is effected by radiation and therefore lower doses must be used to spare healthy tissue.

A method to compensate for this motion is gating which means that the irradiation beam is switched off each time the target moves out of a predefined window. The movement of the target or tumour can be determined using data of a sensor or camera, such as infrared tracking, to obtain information about the movement of the body, e.g. the respiratory curve of a patient.

A further method to compensate for this motion is chasing, where the source of radiation is actively tracked or moved so that the irradiation beam is always focussed on the object or target.

A method for determining the state of a moving body, such as the respiratory or pulsation state of a patient, which moves permanently and/or periodically, includes acquiring an image sequence, which can be an x-ray image sequence. This image sequence is compared to a prior taken sequence, such as a 4D CT scan, to determine the state of the body. Thus, the position or trajectory of the object or tumour correlated to the movement cycle or breathing state can be calculated.

The 4D CT scan can be segmented and/or otherwise analyzed, so that for each scan or dataset of the 4D CT the state, such as the respiratory state, is known.

If it can be determined to which prior taken scan or dataset the image sequence corresponds, the moving state or respiratory state corresponding to the respective image sequence or the respective images being part of the image sequence is known.

If just a single image or shot is taken and this single image should be compared to a previously taken sequence to determine the respiratory state, the image found to best match one image or shot in the previous taken image series is probably an image not having the same respiratory state as the found “matching” image.

The reason is that single images taken during free-breathing do not differ that much and the comparison of a single image to images of a series is quite complicated and does not necessarily provide the desired result.

If, however, the later taken image sequence(s) are compared as sequence (and not as individual pictures) with the previously taken image sequence, which is possible if the previously taken and later taken image sequence is taken with the same frequency, a whole sequence can be taken into account, thus eliminating the need to find a match for just one single shot in a series of previously taken images.

According to an embodiment of the invention, the frequency used for taking the image sequence or image sequences is preferably the same or close to the frequency of the previously taken images or datasets, such as the previously taken 4D volume scan. Using the same frequency provides the advantage that the whole sequence of images can be taken into account to compare this image sequence with the previous taken sequence.

Considering for example breathing motion, there are basically two indicators: the ribcage and the diaphragm.

It is obvious that the term “same frequency” should be understood to also cover (integer) multiples of the imaging frequency of one image series. If for example the prior taken image series is taken with the frequency 2*f0 and the later taken image sequence is taken with the frequency f0, then the comparison can be made between the later taken image series and the first taken image series while leaving out every second picture of the first taken image series.

In general, it is not essential that the frequency has to be the same, as long as the time or time differences between the respective images of one image series is known, so that the respective single images of each image series can be compared to probably corresponding images of a different image series having basically the same or a similar time difference in between.

If an image series of two-dimensional images is compared to a series of 3D images, such as a 4D CT, then a reconstruction can be performed to obtain 2D images out of the 3D image series. A well-known method for obtaining radiographs out of a 3D CT-scan is to use digital reconstructed radiographs (DRR), which DRRs can be compared to the probably later taken image series.

It is noted that the later taken image series does not necessarily have to be taken from the same point of view or angle, as long as this imaging parameter, i.e. the direction from which the image is taken, is known and recorded. Using this positional information of the camera or sensor, the corresponding DRR can be calculated from each 3D data volume.

According to a further aspect, the invention provides a method for determining the way of treatment of an object within a moving body, preferably by radiation therapy or radiosurgery.

A dataset, such as a 4D CT, is provided, which is preferably segmented and includes information about the region of interest which can include information about a target volume and information about organs at risk which should not be affected by the treatment and should for example not be irradiated by using radiation therapy as treatment method.

The position and/or orientation of the regions of interest are analysed in every bin which enables the system to provide guidance to the user.

A possible guidance can be a recommendation concerning the type of treatment, i.e. whether or not gating and/or chasing is recommended.

A further recommendation can include an indication which bins should be used for the treatment. Based on the relative position and/or orientation of the planning target volume and one or more critical regions or organs at risk, specific bins can be elected for treatments, whereas other bins can for example be sorted out, if an organ at risk is closer to the planning target volume than a predefined safety distance, so that no therapy or irradiation is performed during that bin.

It is possible to combine two bins to a “treatment bin” if these two or more bins do not differ regarding a specified criterion, e.g. the distance between the planning target volume and an organ at risk.

It is possible to generate further synthetic bins using known techniques such as morphing or interpolation to generate e.g. a bin “intermediate”, if only data is available for the respiratory state “inhaled” and “exhaled”. If more bins are created; a more accurate 4D dose distribution can be calculated and used for treatment.

The invention is in particular directed to the following preferred embodiments:

A) A method for determining the position of an object moving within a body, wherein the body is connected to markers, a movement signal is determined based on the measured movement of the markers, a pre-segmented division of all possible acquisition angles is made, images are taken from the object from different angles and in more than one segment using a camera or detector, wherein the camera or detector is moved with respect to the object partly or fully around the object over more than one segment, it is determined in which segment the most images corresponding to a predefined cycle of the movement signal are taken, and using at least some or all of the images of the segment containing the most images for a specified movement cycle to, an image of the object is reconstructed a tomographic image of the object by digital tomosynthesis, wherein the plane perpendicular to the bisector of the selected segment is the plane of the tomographic image to be computed.

B) The method according to embodiment A), wherein the method is performed for each segment of a movement cycle of the movement signal.

C) The method according to embodiment A), wherein the reconstructed or tomographic image is compared with a pre-segmented 4D CT dataset to obtain the outline or surface of the object.

D) The method according to the previous embodiment, wherein a trajectory of the moving object is calculated using the reconstructed or tomographic images.

E) The method according to embodiment A), wherein the movement signal is a breathing signal or a pulsation signal.

F) The method according to the previous embodiment, wherein the breathing signal is divided at least into the following states: Inhaled, nearly inhaled, intermediate, nearly exhaled and exhaled.

G) The method according to embodiment A), wherein the segment opposing the segment with the most images is used for reconstructing the image or topographic image.

H) The method according to embodiment A), wherein at least one image taken from a different angle or from a 90 degree angle with respect to the bisector of the selected segment is used to determine the position of the object.

I) The method according to embodiment A), wherein the sensor or camera moves along a circle or section of a circle.

J) A computer program which, when loaded or running on a computer, performs the method of embodiment A).

K) A program storage medium or computer program product comprising the program of the previous embodiment.

L) An apparatus for determining the position of an object moving within a body comprising: a tracking system which can detect the position of external markers fixed to at least part of the surface of the moving body; and a camera or detector which can be moved partly or fully around the body over more than one segment, the camera and the tracking system being connected to a computational unit correlating the marker signals obtained by the tracking system and the camera signals including the image data and image parameters comprising at least the time the image has been taken and the acquisition angle of the camera at the time the image was taken, the computational unit adapted to carry out the method of embodiment A).

M) A method for determining the parameters of a treatment of an object moving within a body, wherein a movement indication is provided and bins are generated using the method for determining the position of an object according to embodiment A).

N) The method according to embodiment M), wherein a synthetic bin is generated by morphing or interpolation of two bins.

O) The method according to embodiment M), wherein the treatment is radiation therapy.

The invention is furthermore directed to the following further preferred embodiments:

P) A method for determining the state of a moving body, wherein a dataset of the moving body including several images taken at different times is compared to a second dataset or image sequence of the body to find the best correspondence between the first dataset and the second dataset, wherein the first dataset is taken with the same frequency as the second dataset or one of the first and second frequencies is a multiple of the other frequency.

Q) The method according to the embodiment P), wherein the second dataset is shifted with respect to the first dataset in time to determine a correlation or matching value.

R) The method according to embodiment P), wherein the first dataset is a 4D computer tomography (CT) dataset.

S) The method according to embodiment P), wherein a digital reconstructed radiograph (DRR) is reconstructed from each three-dimensional dataset of the 4D CT.

### BRIEF DESCRIPTION OF THE DRAWINGS

FIG. 1A: is a diagram illustration of a device used for radiotherapy controlled according to the invention from a first perspective;

FIG. 1B: is a diagram illustration of a device used for radiotherapy controlled according to the invention from a second perspective;

FIG. 1C: is a diagram illustration of a prior art imaging device which is configured to move around the isocentre;

FIG. 1D: is a diagram illustration of the inventive method which involves keeping the position of the imaging apparatus fixed relative to the isocentre and rotating the patient around the isocentre of imaging;

FIGS. 2A to 2C: show a respiratory curve being divided into respiratory states;

FIGS. 3A to 3C: illustrate methods for DTS image reconstruction;

FIG. 4: is a flowchart illustrating a method for determining the respiratory state;

FIGS. 5A to 5C: illustrate a registration procedure performed according to an embodiment of the invention;

FIG. 6: shows the matching of a sequence to treatment bins;

FIGS. 7A to 7C: show the fine adjustment using intensity-based registration;

FIG. 8: shows the fitting of a trajectory through sample point;

FIG. 9: shows the segmentation of the trajectory of FIG. 8 into treatment bins;

FIGS. 10A and 10B: illustrate the generation of treatment parameters;

FIG. 11: shows the contour-based detection of a planning target volume; and

FIGS. 12A to 12C: illustrate the reconstruction of object data.

### DETAILED DESCRIPTION OF PREFERRED EMBODIMENTS

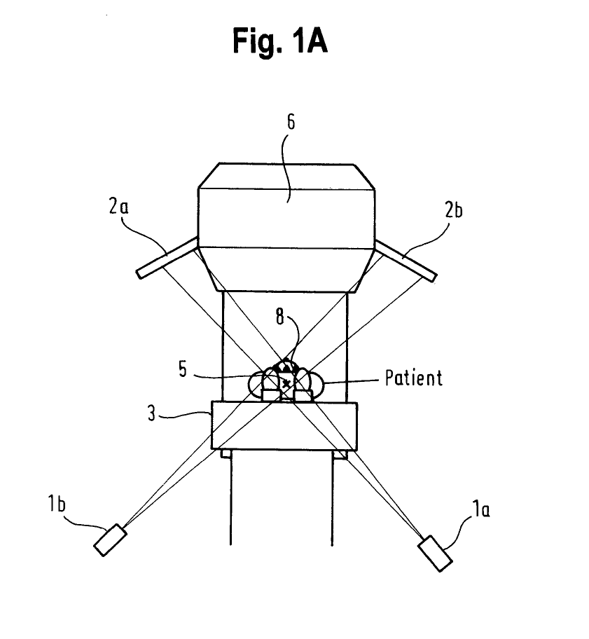

As shown in FIG. 1A, a patient is positioned on a treatment table. An irradiation device, such as a linear accelerator, can be moved with respect to the patient. An x-ray source being positioned on one side of the patient emits x-rays in the direction of an x-ray detector positioned on the opposing side to obtain 2D images of a region of interest of the patient. The x-ray source and the x-ray detector can be connected to the beam source or linear accelerator or can be movable independent thereof.

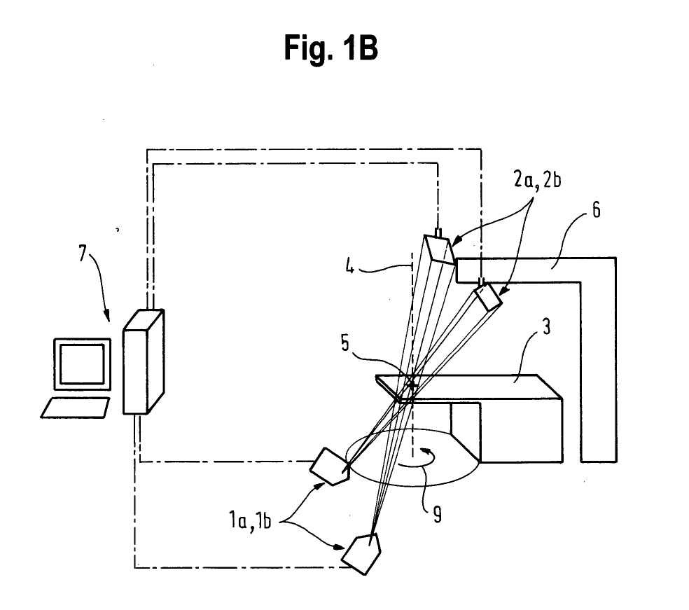

As shown in FIG. 1A, external markers 8, such as reflecting spots, are connected or stuck to the surface, such as the chest, of the patient. The reflections of the external markers can be detected by a tracking system, which generates as an output a respiratory curve as shown in FIG. 2. In FIG. 1B, the isocentre 5 of the imaging device comprising X-ray sources 1a, 1b and X-ray detectors (in particular digital camera detectors) 2a, 2b is shown. The isocentre 5 is the point which results from intersection of the cones emitted from the X-ray sources 1a, 1b. In the example of FIGS. 1A, 1B a spatially fixed vertical axis 4 passes through the isocentre 5; a patient bed 3 can rotate about this axis in order to perform the method in accordance with the invention. This can be realized, for example, by arranging the bed 3 on a rotating table on the floor. It should also be noted that the axis 4 does not necessarily have to be an isocentre axis, i.e. does not necessarily have to intersect the isocentre. Rather, it is sufficient that the axis is basically fixed and its path is known. The patient bed 3 is positioned under a LINAC (linear accelerator) gantry 6. Two X-ray sources (in particular two X-ray tubes) 1a, 1b are mounted below the patient bed 3 and the gantry 6, in the present example they are mounted in the floor. To X-ray detectors indicated by reference signs 2a, 2b are situated above the patient bed 3, preferably fastened to the sealing or a stationary part of the LINAC gantry 6. The detectors can be constructed in particular on the basis of amorphous silicon. A computer system 6 is connected to the X-ray tubes 1a, 1b and the X-ray detectors 2a, 2b. The computer system 6 serves to acquire the X-ray images and to reconstruct the volume dataset, for example a reconstructed CT dataset, from the image information contained in the X-ray images generated by interaction of the X-ray tubes 1a, 1b and the X-ray detectors 2a, 2b.

Furthermore, a number of means can also be provided which are not shown in FIG. 1A or FIG. 1B. For example, a navigation or tracking system may be provided which is configured to measure the rotational angle 9 of the patient bed 3 within the framework of the present invention. The rotational angle 9 can also be determined directly, for example on a rotating table using known angle-measuring devices. The setup shown in FIG. 1B essentially corresponds to the setup disclosed in U.S. Pat. No. 7,324,626 B2, the entire disclosure of which being incorporated into the present disclosure by reference. In particular, the setup of FIG. 1B may be used in analogy to the manner as disclosed in U.S. Pat. No. 7,324,626 B2. FIG. 1C shows a prior art method of taking the X-ray images for determining the position of an object moving within a patient's body. An X-ray source 1 having a fixed position relative to an X-ray detectors 2 is rotated together with the X-ray detector 2 around the position of the object. Each rotational position of the X-ray source 1 and the X-ray detector 2, an image is taken, whereby an imaging isocentre 5 is formed in which the object preferably lies. According to the present invention and as shown in FIGS. 1B and 1D, the position of the X-ray source 1 and the X-ray detector 2 is kept fixed and the patient is rotated by an angle 9 around the imaging isocentre 5.

FIG. 2A shows a respiratory curve generated from a sequence of images referred to as sample points.

As shown in FIGS. 2B and 2C, the respiratory curve can be segmented into several different states, being for example inhaled, nearly inhaled, intermediate 1, intermediate 2, nearly exhaled and exhaled.

By moving the x-ray detector shown in FIG. 1C relative to the patient, a series of images is taken, wherein the rotational position of the patient and the time at which the respective image is taken is recorded. Using the information from the respiratory curve acquired simultaneously with the image acquisition by the x-ray detector, a series of images taken from different positions or angles can be collected or stored for each respiratory state.

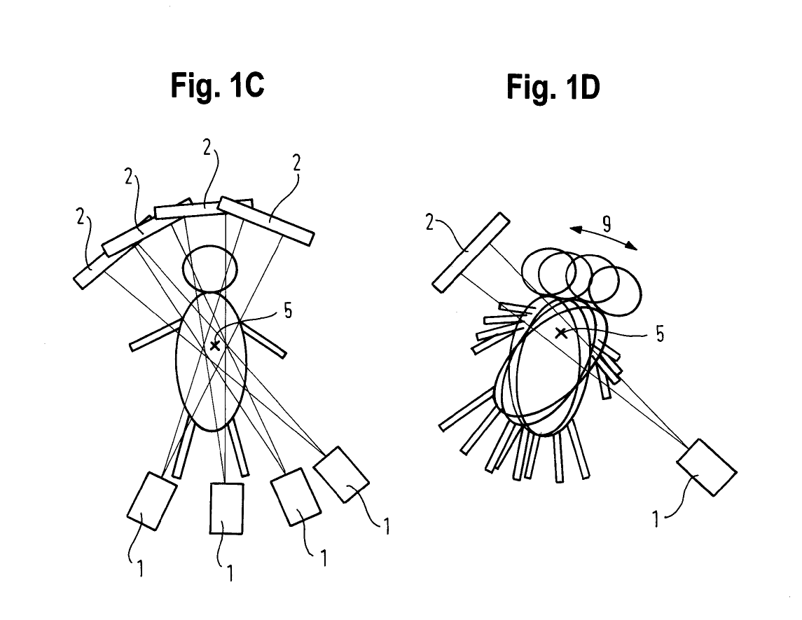

FIGS. 3A to 3C show as an exemplary embodiment the respiratory state “nearly inhaled”, where a series of images is taken under respective different angles at the same or at later or earlier respiratory states “nearly inhaled” of a different cycle during some full breathing cycles. The circle representing a 360 degree angle corresponding to the camera position as shown in FIG. 3A is divided into 8 segments. After the image acquisition with the x-ray detector is finished, it is determined in which of the 8 segments the biggest accumulation of images being shown as small circles is.

FIG. 3B shows the determined segment found to include the largest number of images being the segment from which the DTS is computed in the next step. The plane perpendicular to the bisector of the selected segment is the plane of the tomographic image to be computed, as shown in FIG. 3C.

Thus, tomographic images can be computed for multiple respiratory states by repeating the steps explained with reference to FIG. 3 for every single respiratory state. Using the known camera parameters of every tomographic image (angle of bisector) and the segmentation data of the corresponding respiratory state (bin), the shape of the target can be computed and can be superimposed on the image. Deviations can be compensated for using an intensity-based registration to obtain the accurate position of the target in every tomographic image. Preferably intensity-based registration includes only a rigid transformation. However, it is also possible to perform an elastic registration.

To ensure robust registration results, a second tomographic image, perpendicular to the existing one, can be taken into account for the same respiratory state, as shown in FIG. 3C with the arrow DTS 2. For example, if the main direction of tumour motion is the same as the viewing direction of the reconstructed DTS image, it will be very difficult to get accurate registration results. But if a further image taken from another viewing angle (e.g. +90 degrees) is taken into account, this problem can be solved, so that 3D information is obtained.

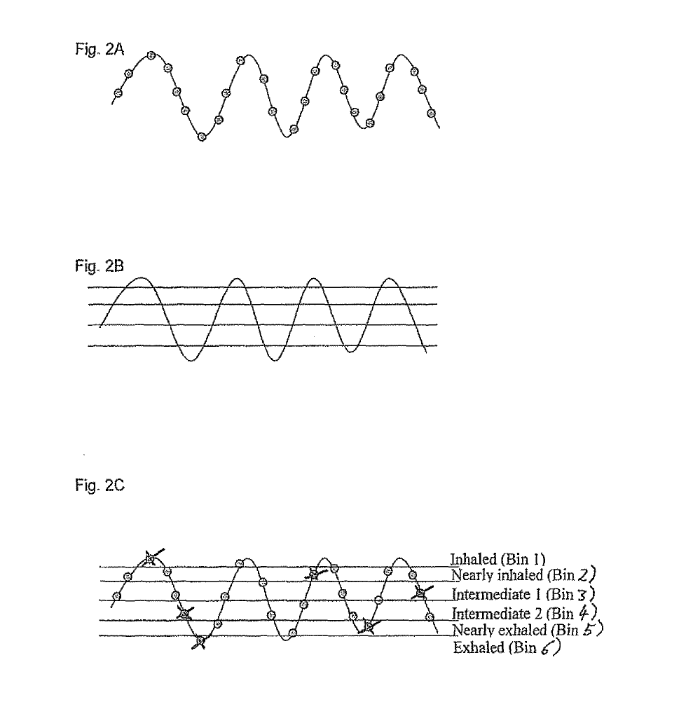

FIG. 4 shows a registration procedure to match a sequence of 2D images to a previously recorded dataset, such as a 4D volume scan of a patient.

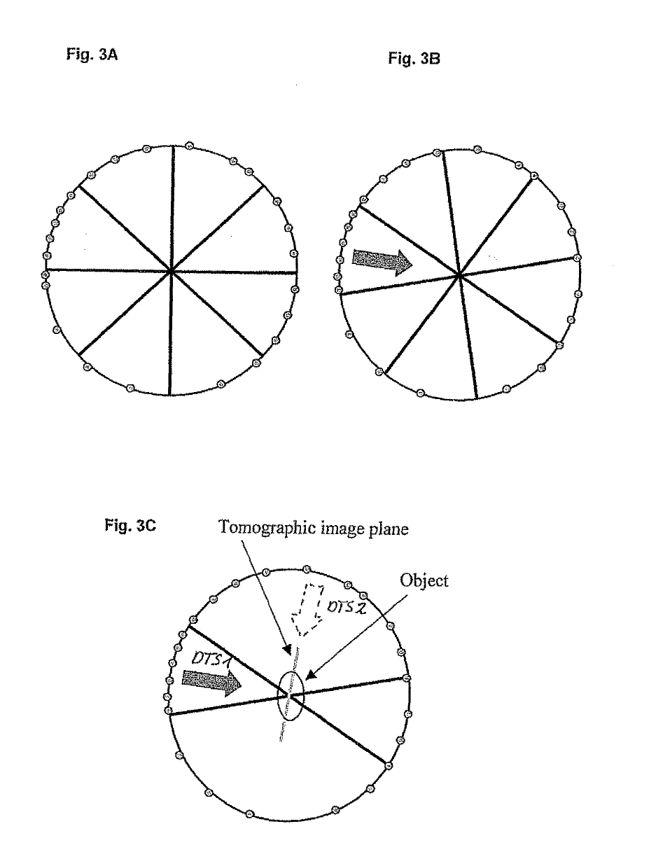

According to the shown embodiment, the 2D image sequence is acquired with the same frequency, so that the sequence can be matched to the 4D volume scan, as explained hereinafter with reference to FIG. 5.

If the time span of an average respiratory cycle of a specific patient is for example about five seconds and a 4D volume scan consists of 8 bins, the images of the sequence should be taken every (5000 ms/(8×2−1))=333 ms.

FIG. 5 shows the registration method for matching the 2D image sequence Seq 1, Seq 2, Seq 3 to the 4D CT sequence Bin 1, Bin 2, Bin 3, Bin 4, Bin 3, Bin 2, . . . .

The bold line shown below the respective designation of the sequence or Bin should symbolize the state of the diaphragm being a possible indicator for the respiratory state.

As can be seen in FIGS. 5A and 5B, there is no match between the respective sequence and the bins. The sequence is shifted witch respect to the bins until a match is reached, as shown in FIG. 5C.

The registration is preferably performed 2D to 2D, i.e. a pre-generated DRRs shall be matched to n images of the sequence. The accumulate similarity measure values shall be optimised and the best match sorts the images of the sequence to the respiratory states of the 4D volume scan.

Similarity measures are known from the above mentioned K. Berlinger, “Fiducial-Less Compensation of Breathing Motion in Extracranial Radiosurgery”, Dissertation, Fakultät für Informatik, Technische Universität München; which is included by reference. Examples are Correlation Coefficients or Mutual Information.

When using stereo x-ray imaging, this procedure can be performed twice, i.e. for each camera, to further enhance the robustness by taking into account both results.

Preferably, the two x-ray images of the pair of x-ray images are perpendicular to each other and are taken simultaneously. To perform the 2D/4D registration, several independent 2D/3D registration processes using e.g. DRRs can be performed. Both x-ray images are successively matched to all bins of the 4D CT and the best match yields the respiratory states.

As shown in FIG. 2A, the images of the sequence and their position in time of the corresponding respiratory curve is depicted. The respiratory curve from IR is used to select one image per treatment bin (respiratory state) and to sort the images by the respiratory state, as shown in FIG. 2C. All points on the respiratory curve are sample points where an x-ray image has been taken. The sample points marked with an “x” additionally serve as control points for segmenting the trajectory computed afterwards.

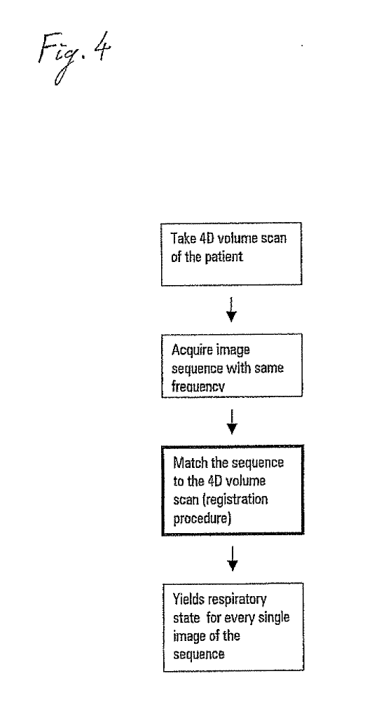

The sequence is matched to the treatment bins, as shown in FIG. 6. The images of the sequence are moved synchronously over the treatment bins (DRRs) and the accumulated similarly measure is optimised.

The result sorts every single image to a bin and therefore to a respiratory state. The isocentres of the bins serve as control points of the trajectory, i.e. the isocentres were determined in the planning phase.

If no 4D CT is available (3D case), the planning target volume (PTV) can be manually fitted to some well distributed single images. In the 3D and 4D case, the contour of the PTV can be interpolated geometrically over all images of the sequence.

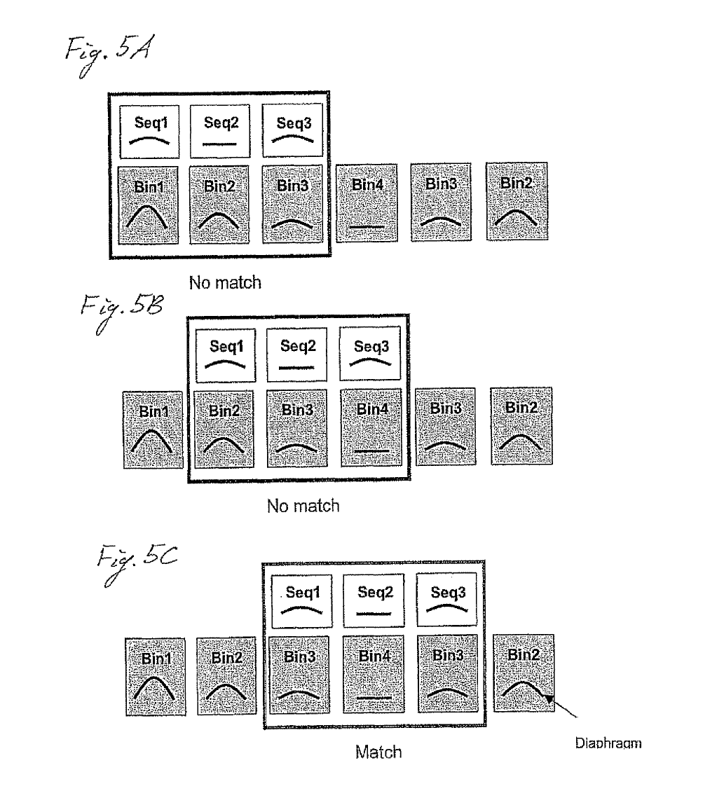

FIG. 7A shows an example, where the first and the last contour match is known and between these images the interpolation is performed, yielding an approximate match.

Fine adjustment using intensity-based registration can be performed for every single image, so that no sequence matching is performed.

FIG. 7B shows that the intensity of the target is now taken into account.

FIG. 7C shows the thereby reached perfect match.

Finally, visual inspection can be performed by the user and if necessary manual correction can be performed.

So the position of the PTV in every single image can be determined, which can be used to define a trajectory in the next step.

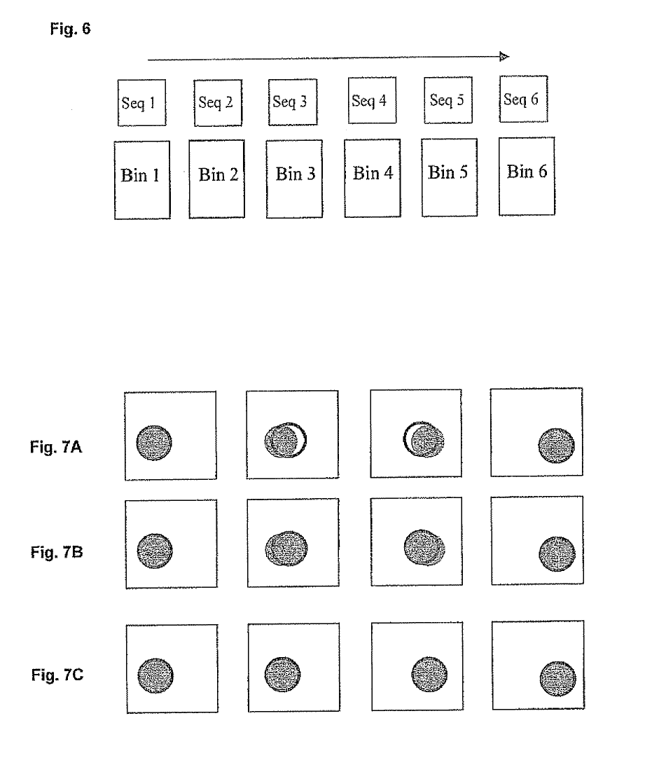

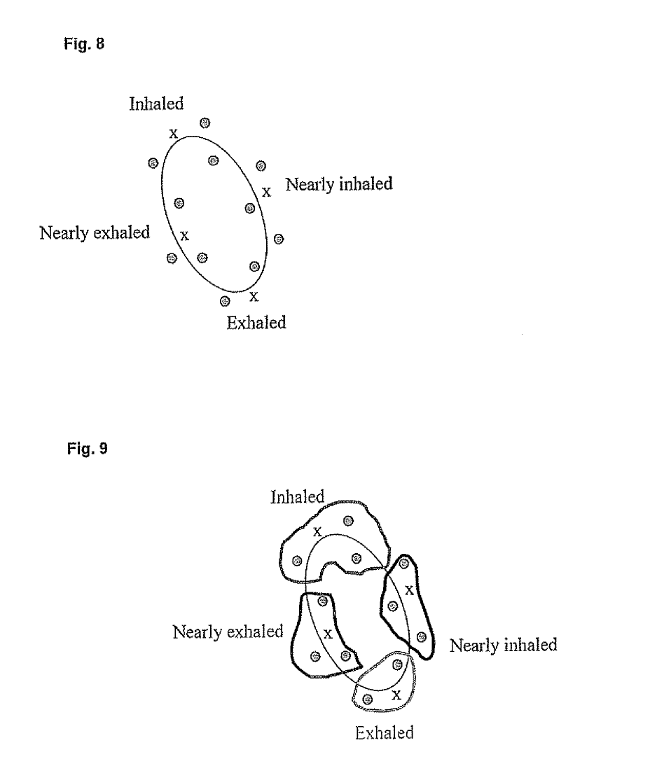

For generating the parameters for treatment (4D), a trajectory is fitted through the sample points, as shown in FIG. 8, and the control points are used, wherein the trajectory is divided into (breathing phase) segments, as shown in FIG. 9.

Images located between two control points (marked as ‘x’ in FIGS. 8 and 9), are sorted to a respiratory state or control point by matching these to the two competing bins. The image is assigned to the best matching control point. After this sorting procedure is completed, the segments can be determined as visualized in FIG. 9. Each segment stands for a specific respiratory state and therefore treatment bin.

To assist in the adding of trajectory segments to a chasing area (the chasing area is the area where the beam actually follows the target, outside this area the beam is switched off (gating)), the standard deviation from sample points of a specific segment to the trajectory taking into account the relative accumulation should be minimized. It is advantageous to find the most “stable” or best reproducible trajectory or trajectories to be used for later treatment by irradiation. Having determined the best reproducible trajectories, the treatment time can be minimized since the beam can be quite exactly focussed while largely sparing out healthy tissue.

Regions neighboring critical bins (segments) are omitted
User control:
   Visualization of DRR of specific bin with organs at risk (OAR) and isodoses drawn in
   Treatment time
   Expected positioning deviation (how “reproducible” is a trajectory)

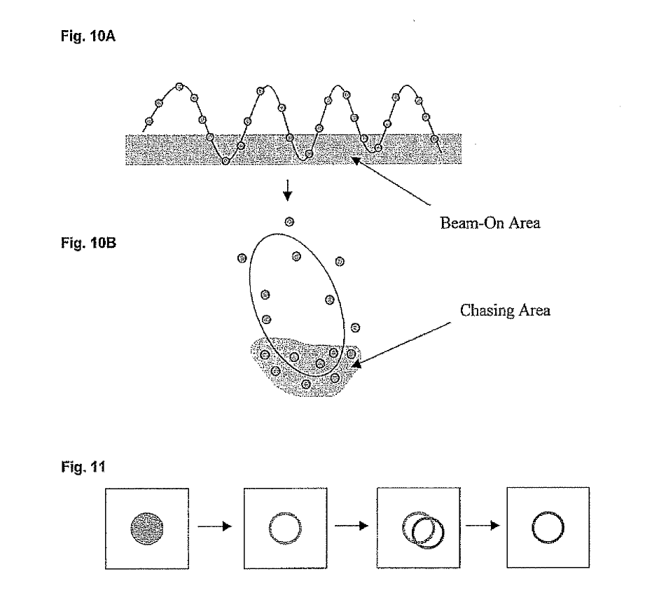

For generating the parameters for treatment (3D) the following steps are performed:
Fitting of trajectory through sample points
Definition of beam-on area in IR respiratory curve
Computation of trajectory segment (chasing area) based on sample points located in the beam-on area (see FIG. 10)
Display of trajectory segments with high standard deviations
Display of expected treatment time
Display of the selected trajectory segment
Manual readjustment to optimize treatment time, standard deviations and chasing area
Automatical determination of the isocentre (sort of reference isocentre with respect to chasing trajectory)
If necessary, export to treatment planning system (TPS) for plan-update

The treatment in the 3D and 4D case have as input:
Gained correlation of IR-signal and trajectory segment(s)
Isocentre

Procedure:
Positioning of the determined patient isocentre to the machine isocentre
Continuously recording of IR-signal and transferring the signal into position on the trajectory
Within the segment to treat: chasing; outside: gating
Use gating (beam off) if an error occurs in the above computations, e.g.:
   IR marker is not visible
   Changed pattern of the marker geometry
   No corresponding trajectory position to current signal in correlation model
It is possible to take verification shots
   Based on trajectory position drawing in of the planning target volume (PTV) to enable a visual inspection and if necessary an intervention
It is possible to continuously take images during treatment (yields sequence with lower frequency)
   To document treatment
   To permanently check and update trajectory automatically
   Export information to TPS for possible plan-update

Error handling, e.g. during treatment, can have as input:
old image sequence
new image sequence

Procedure:

A) Displaced respiratory curve/Unchanged trajectory
i. Registration of old and new sequence (Algorithm can be close to that described with reference to FIGS. 2C and 6, but instead of the DRR sequence the old sequence is used)
ii. Showing tumour positions of old sequence in new one
   =>PTV matches to new images
   =>Correlation between IR-Signal and trajectory will be updated

B) Changed trajectory
i. Registration of old and new sequence (see above)
ii. Automatic detection if an update is necessary: indicator is a towards inhalation falling similarity measure value (see e.g. K. Berlinger, “Fiducial-Less Compensation of Breathing Motion in Extracranial Radiosurgery”, Dissertation, Fakultät für Informatik, Technische Universitat München; section 2.3.3)
   =>Automatic image fusion (image to image, not whole sequence as described when generating the sample points of the treatment trajectory) to get updated tumour positions and therefore the updated trajectory.

Incremental Setup of Gating and/or Chasing (for example treatment on a different day)

A) First fraction: as described so far, the DRR sequence generated from the treatment bins is used for the initial sequence matching (as described when generating the sample points of the treatment trajectory; FIGS. 2C and 6).

B) Later fractions: instead of the DRR sequence, the sequence of the last fraction can be used for the initial registration procedure.

For a plan-update the following can be done:

A) Recommended trajectory segment (chasing area) is different from initially planned bin (when using 4D-CT a bin is equivalent to a trajectory segment)
a. Selection of the recommended bin for treatment
b. Planning of new beam configuration taking into account changed relative position and orientation of PTV and OARs to each other

B) Update of the planned dose distribution
a. Detection of the actual PTV position in the control images using intensity-based registration (as described when generating the sample points of the treatment trajectory)
b. Computation of the dose distribution actually applied to the target
c. Taking these results into account, update the beam configuration in a way to reach the originally wanted dose distribution

Image subtraction can be performed to enable a detection of the tumour in every single verification shot. Thus, there is no need for using implanted markers anymore. An initially taken image sequence of the respiratory cycle forms the basis of this approach. The thereby gained information is stored in an image mask. Applying this mask to any new verification shot yields an image which emphasizes the contour of the tumour. The moving object is separated from the background.

There are two ways to generate the mask

1. Compute a mean image of the sequence by averaging the pixel values of the sequence. That means for every pixel of the destination image:

$${I}_{Mask} ( x , y ) = \frac{1}{n} {\sum }_{i = l}^{n} {Seq}_{i} ( x , y )$$

The average image has to be subtracted from the verification shot to obtain the image with emphasized target contour.

2. Compute a maximum image of the sequence. That means for every pixel of the destination image:

I_{Mask}(x,y)=MAXᵢ₌ₗⁿ(Seqᵢ(x,y))

In this case the verification shot has to be subtracted from the maximum image to obtain the image with emphasized target contour.

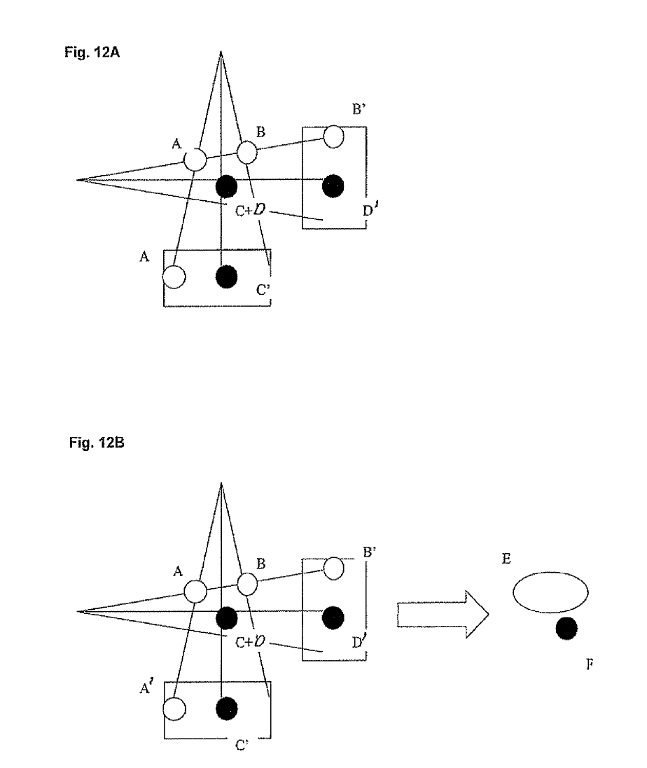

For contour-based PTV detection, as shown in FIG. 11, the known contour of the target and an x-ray image containing the target is used as input. The procedure includes the steps:
Applying an edge detector to the X-ray image (e.g. Canny Edge)
Matching of the contour to the edge image
Optimize similarity measure value

Cone-Beam Raw-Data can be used for Sequence Generation having as input raw images of Cone-Beam imaging with known camera position; and the infrared signal. An image sequence with known respiratory states can be obtained: Images are not located in the same plane, but with the known camera parameters this sequence can be matched to a 4D CT, as described when generating the sample points of the treatment trajectory. Furthermore, the Cone-Beam volume is received as output.

Cone-Beam of moving objects can have as input raw images of Cone-Beam imaging with known camera position; and expected position of PTV for every raw image (e.g. based on 4D CT scan and IR signal during Cone Beam acquisition).

As output the reconstructed Cone Beam dataset can be obtained.

The advantage of this reconstruction method is to properly display an object that was moving during the acquisition of the raw images.

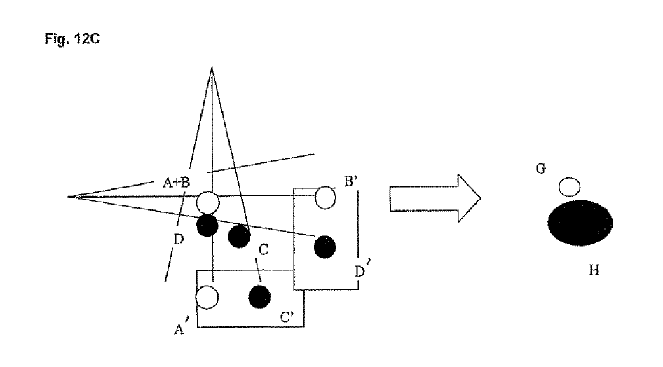

During the acquisition of Cone Beam raw images the objects are projected to the raw images. In FIG. 12A below the non-moving object (black circle) is at the same position C+D during the acquisition of two raw images. It is projected to position C′ and D′ on the raw images. Another object (hollow circle) moves during acquisition. It is a different position A and B during acquisition of the two raw images. It is projected to position A′ and B′ in the raw images.

During a conventional reconstruction, a mathematical algorithm solves the inverse equation to calculate the original density of the voxels. For non-moving objects like the filled black circle in FIG. 12B, the reconstruction result is of sufficient quality. If the object moves during acquisition of the raw images, the reconstruction quality is degraded. The object at position C′ and D′ is properly reconstructed to position C+D in the voxel set. Accordingly the Cone Beam data set will display the black circle (F). The hollow circle at positions A′ and B′ in the images is not properly reconstructed because position A and B differ. The voxel set will show a distorted and blurred object E.

The new reconstruction algorithm shown in FIG. 12C takes the position C+D during acquisition into account. It calculates the projection parameters of the Object (hollow circle) to the raw images. These parameters depend on the object's position during acquisition of the images. By doing this the beams through the object on the raw images (A′ and B′) will intersect at the corresponding voxel in the Cone Beam data set (A+B)). The object is reconstructed to the correct shape G. Instead the stationary object is now distorted to the shape H.

1. A method for determining a position of an object moving within a body, wherein the body is connected to markers, a movement signal is determined based on a measured movement of the markers, images are taken of the object using an imaging apparatus, wherein the patient is rotated in an isocentric movement with respect to an imaging isocentre of the imaging apparatus, it is determined from which direction or range of angles or segment the most images corresponding to a predefined cycle of the movement signal are taken, and using at least some or all of the images of the segment containing the most images for a specified movement cycle, an image of the object is reconstructed.

2. The method according to claim 1, wherein the reconstructed image is a tomographic image.

3. The method according claim 1, wherein the image is reconstructed by digital tomosynthesis (DTS).

4. The method according to claim 1, wherein the method is performed for each segment of a movement cycle of the movement signal.

5. The method according to claim 1, wherein the reconstructed or tomographic image is compared with a pre-segmented 4D CT dataset to obtain can outline or surface of the object.

6. The method according to claim 5, wherein a trajectory of the moving object is calculated using the reconstructed or tomographic images.

7. The method according to claim 6, wherein the movement signal is a breathing signal and the breathing signal is divided at least into the following states: inhaled, nearly inhaled, intermediate, nearly exhaled and exhaled.

8. The method according to claim 1, wherein the segment opposing the segment with the most images is used for reconstructing the image or tomographic image.

9. The method according to claim 1, wherein at least one image taken from a different angle or from a 90 degree angle with respect to the bisector of the selected segment is used to determine the position of the object.

10. A method for determining the parameters of a treatment of an object moving within a body, wherein a movement indication is provided and treatment bins are generated using the method for determining the position of an object according to claim 1.

11. The method according to claim 10, wherein a synthetic treatment bin is generated by morphing or interpolation of two bins.

12. The method according to claim 10, wherein the treatment is radiation therapy.

13. A computer program embodied on a non-transitory computer-readable program storage medium, wherein the computer program, when loaded or running on a computer, causes the computer to perform a method for determining a position of an object moving within a body, wherein the body is connected to markers, a movement signal is determined based on a measured movement of the markers, images are taken of the object using an imaging apparatus, wherein the patient is rotated in an isocentric movement with respect to an imaging isocentre of the imaging apparatus, it is determined from which direction or range of angles or segment the most images corresponding to a predefined cycle of the movement signal are taken, and using at least some or all of the images of the segment containing the most images for a specified movement cycle, an image of the object is reconstructed.

14. A non-transitory computer-readable program storage medium or computer program product storing code representing a computer program which, when loaded or running on a computer, causes the computer to perform a method for determining a position of an object moving within a body, wherein the body is connected to markers, a movement signal is determined based on a measured movement of the markers, images are taken of the object using an imaging apparatus, wherein the patient is rotated in an isocentric movement with respect to an imaging isocentre of the imaging apparatus, it is determined from which direction or range of angles or segment the most images corresponding to a predefined cycle of the movement signal are taken, and using at least some or all of the images of the segment containing the most images for a specified movement cycle, an image of the object is reconstructed.

15. An apparatus for determining the position of an object moving within a body comprising:
a tracking system which can detect a position of external markers fixed to at least part of the surface of the moving body;
an imaging apparatus comprising an irradiation source and a corresponding detector for taking images of the body and a unit for rotating the body in an isocentric movement with respect to an imaging isocentre of the imaging apparatus,
the detector and the tracking system being connected to a computational unit correlating the marker signals obtained by the tracking system, and
the detector signals including the image data and image parameters comprising at least the time the image has been taken and the rotational position of the body at the time the image was taken,
the computational unit determining a segment or viewing range within or from which the most images were taken and elects this segment for image reconstruction.
